(19) United States
(12) Patent Application Publication
(10) Pub. No.: US 2020/0180278 A1
(43) Pub. Date: Jun. 11, 2020

(54) HIGH HEAT TRANSFER, STRENGTHENED GLASS LAMINATE AND RELATED HEATING SYSTEM AND METHOD

(71) Applicant: CORNING INCORPORATED, CORNING, NY (US)

(72) Inventors: Vikram BHATIA, Painted Post, NY (US); Ah-Young PARK, Yuseong-Gu, Daejeon (KR); Yousef Kayed QAROUSH, Painted Post, NY (US); David Evan ROBINSON, Corning, NY (US)

(21) Appl. No.: 16/608,686

(22) PCT Filed: Apr. 26, 2018
(86) PCT No.: PCT/US2018/029557

§ 371 Date: Oct. 25, 2019

Related U.S. Application Data
(60) Provisional application No. 62/490,231, filed on Apr. 26, 2017.

(51) Int. Cl. B32B 17/10

(52) U.S. Cl. CPC B32B 17/10568; B32B 17/10743; B32B 17/10871; B32B 17/10385; B32B 2307/732; B32B 2309/105; B32B 2605/006; B32B 2307/302

(57) ABSTRACT

A glass laminate article having high efficiency heat transfer characteristics and related systems and methods are provided. The glass laminate article has a thin, high heat conductive inner glass layer that efficiently transfers heat from a heating system throughout the glass article. The glass laminate article may be used as a vehicle window and used as part of a heating system and method for defogging or defrosting the vehicle window. The glass laminate article may include a heating coating adjacent an outer glass layer which further improves heating efficiency.

### CROSS-REFERENCE TO RELATED APPLICATIONS

This application claims the benefit of priority under 35 U.S.C. § 119 of U.S. Provisional Application Ser. No. 62/490,231 filed on Apr. 26, 2017, the content of which is relied upon and incorporated herein by reference in its entirety.

### BACKGROUND

The disclosure relates generally to a laminate comprising a strengthened glass layer, and specifically to such a laminate providing improved heating/heat transfer properties. Such heat transfer properties allow the laminate to have a high level of defogging and defrosting performance when the laminate is used as windows and glazing in various applications including architectural and transportation applications (e.g., vehicles including automobiles and trucks, rolling stock, locomotive and airplanes).

### SUMMARY

One embodiment of the disclosure relates to a glass laminate article including a strengthened inner glass layer, an interlayer disposed on the outer surface of the inner glass layer and an external glass layer. The strengthened inner glass layer includes an inner surface, an outer surface opposite the inner surface, and an average thickness between the inner and outer surfaces in a range from 0.05 mm to 1 mm. The external glass layer includes an inner surface, an outer surface and an average thickness between the inner and outer surfaces in a range from 1 mm to 4 mm. The glass laminate article includes a heating coating located between the inner surface of the external glass layer and the interlayer.

An additional embodiment of the disclosure relates to a system for efficiently heating an external surface of a glass laminate article. The system includes a strengthened inner glass layer having an inner surface, an outer surface opposite the inner surface, and an average thickness between the inner and outer surfaces of 0.05 mm and 1.5 mm. The system includes an interlayer disposed on the outer surface of the inner glass layer. The system includes an external glass layer having an inner surface, an outer surface, and an average thickness between the inner surface and the outer surface that is greater than the average thickness of the strengthened inner glass layer. The system includes a heating coating located between the interlayer and the external glass layer. The heating coating delivers a power of at least 400 W per m² of area of the inner surface of the external glass layer to the glass laminate article.

An additional embodiment of the disclosure relates to a method of efficiently and quickly heating an exterior surface of a window of a vehicle. The method includes heating an inner glass layer of the window. The inner glass layer includes an inner surface defining an interior surface of the vehicle window, an outer surface opposite the inner surface, an average thickness between the inner and outer surfaces of between 0.05 mm and 1 mm and a first glass composition having a thermal conductivity greater than 0.95 W/mK. The method includes heating an outer glass layer of the window. The outer glass layer includes an inner surface facing the exterior surface of the inner glass layer, an outer surface opposite the inner surface and an average thickness between the inner and outer surfaces of greater than 1 mm. Heat is transferred across both the inner glass layer and the outer glass layer to melt frost located on the outer surface of the outer glass layer.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a cross-sectional view of a glass laminate article, according to an exemplary embodiment.

FIG. 2 is a schematic view of a vehicle utilizing a heating system and method including the glass laminate article of FIG. 1, according to an exemplary embodiment.

FIG. 3 is a perspective view of a vehicle utilizing the glass laminate article of FIG. 1 as a vehicle window, according to an exemplary embodiment

FIG. 4 is a plot of melting time and efficiency change of a model of two glass laminate articles given different heating systems, according to an exemplary embodiment.

FIG. 5 is a plot of melting time and efficiency change of a model of two additional glass laminate articles given different heating systems, according to another exemplary embodiment.

FIG. 6 is a plot of melting time and efficiency change of a model of two additional glass laminate articles given different heating systems, according to another exemplary embodiment.

FIG. 7 is a plot of glass temperature vs. heating time of a model of two additional glass laminate articles, according to another exemplary embodiment.

FIG. 8 is a plot of a model showing the effect of the thickness of an inner layer of a glass laminate article on melting time and efficiency, according to an exemplary embodiment.

FIG. 9 is a plot of a model showing the effect of the total thickness of a glass laminate article on melting time, according to an exemplary embodiment.

FIG. 10 is a plot of exterior surface defogging time of a model of six exemplary glass laminate articles given different heating systems, total glass thicknesses and relative humidity, according to another exemplary embodiment.

FIG. 11 is a plot of interior surface defogging time of a model of six exemplary glass laminate articles given different heating systems, total glass thicknesses and relative humidity, according to another exemplary embodiment.

FIG. 12 is a plot of exterior surface defogging efficiency change of a model of six exemplary glass laminate articles having a thin inner layer of Gorilla Glass in place of a thicker SLG inner layer, given different heating systems and relative humidity, according to another exemplary embodiment.

FIG. 13 is a plot of interior surface defogging efficiency change of a model of six exemplary glass laminate articles having a thin inner layer of Gorilla Glass in place of a thicker SLG inner layer, given different heating systems and relative humidity, according to another exemplary embodiment.

### DETAILED DESCRIPTION

Referring generally to the figures, various embodiments of a glass laminate article having high heat transfer properties and related heating, defogging, or defrosting systems and methods are shown. In general, the glass laminate article discussed herein includes a thin, inner layer of glass material that has a high thermal conductivity that facilitates heat transfer from a heating system (e.g., a blown air heating system of a vehicle, an embedded resistive heating layer or a combination thereof) through the glass laminate article. Applicant has determined that such a glass laminate article can greatly improve heat transfer efficiency and both defogging and defrosting times.

In specific embodiments, the inner glass layer of the glass laminate article is a thin layer of highly strengthened glass material, e.g., a chemically strengthened glass material. Applicant has found that the thin inner layer of chemically strengthened glass material increases heat transfer efficiency of the glass laminate while also providing a low weight glass laminate article with high strength, and high shatter resistance. Thus, Applicant has found that the glass laminate article discussed herein is particularly suited as a vehicle window forming part of a heating system that delivers heat through the glass laminate article to defog or defrost the vehicle window.

In particular embodiments, the glass laminate article includes an internal heating layer located between an inner surface of an outer or external glass layer and a bonding interlayer located between the heating layer and the internal glass layer. Applicant has found that by locating a heating layer within the glass laminate article, heating efficiency of the glass laminate article is improved, and particularly the efficiency with which heat is delivered to the outer surface of the glass laminate article is improved. As will be shown and discussed below, this high level of heat transfer provides for significant improvements in heating efficiency and consequently in defogging and defrosting time.

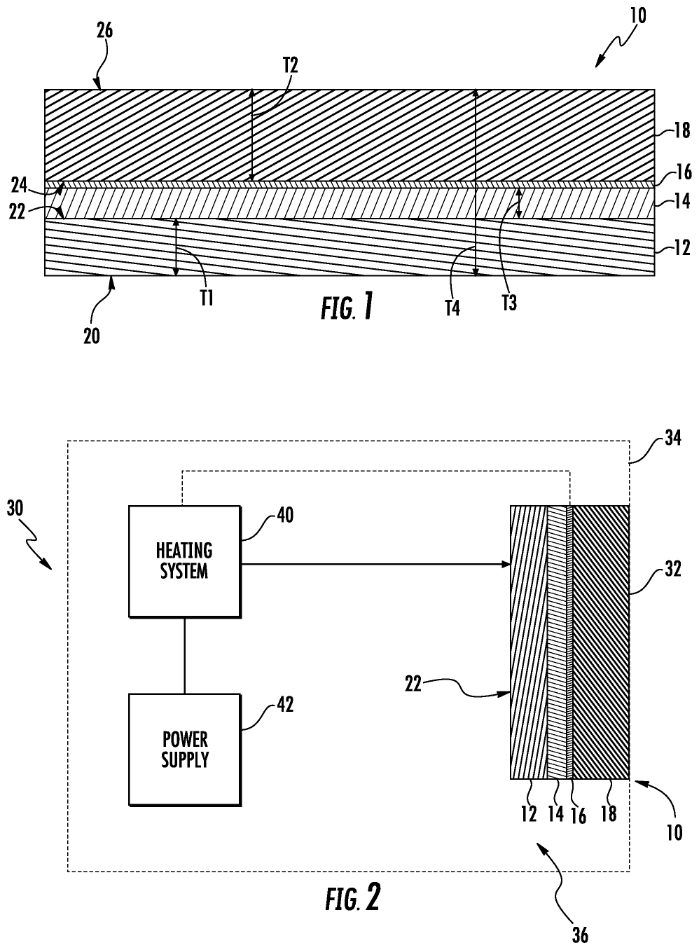

Referring to FIG. 1, a glass laminate article 10 is shown according to an exemplary embodiment. Glass laminate article 10 includes an inner glass layer 12, an interlayer 14, a heating layer or coating 16 and an outer glass layer 18. As shown in FIG. 1, inner glass layer 12 includes an inner surface 20 and an outer surface 22. Interlayer 14 is located or disposed on outer surface 22 of inner glass layer 12, and acts to bind inner glass layer 12, heating coating 16 and outer glass layer 18 into glass laminate article 10.

In various embodiments, inner glass layer 12 is a relatively thin layer of strengthened glass material that has a relatively high level of thermal conductivity combined with a high level of strengthening that Applicant believes suitable for a wide variety of applications including as vehicle windows. In particular embodiments, inner glass layer 12 is formed from a thin layer of chemically strengthened glass that provides both the high strength and high heat conductivity as discussed herein. As will be explained in more detail below, Applicant has found that a glass laminate article with a thin high heat conductive internal glass layer provides improved heat transfer properties that makes glass laminate article 10 particularly useful in conjunction with a variety of heating systems (e.g., vehicle window heating systems) which improves overall heating efficiency, defrost times and/or defogging times.

Interlayer 14 may be a wide variety of materials suitable for bonding together the various layers of glass laminate article 10. In general, interlayer 14 is a polymer binding layer. In specific embodiments, interlayer 14 is a polymer interlayer selected from the group consisting of polyvinyl butyral (PVB), ethylenevinylacetate (EVA), polyvinyl chloride (PVC), ionomers, and thermoplastic polyurethane (TPU). The interlayer may be applied as a preformed polymer interlayer. In some instances, the polymer interlayer can be, for example, a plasticized polyvinyl butyral (PVB) sheet. In various embodiments, the polymer interlayer can comprise a monolithic polymer sheet, a multilayer polymer sheet, or a composite polymer sheet.

Outer glass layer 18 includes an inner surface 24 and an outer surface 26. In general, heating coating 16 is located between inner surface 24 of outer glass layer 18 and interlayer 14. In specific embodiments, as shown in FIG. 1, heating coating 16 is located or disposed on inner surface 24 of outer glass layer 18. In general, heating coating is a thin layer of material that forms a resistive heating element located within glass laminate article 10.

Applicant has found that by positioning heating coating 16 adjacent to or near outer glass layer 18, heating of glass laminate article 10, particularly for heating applications such as defrosting and external surface defogging that rely on heat delivery to the outermost surface of glass laminate article 10, can be greatly improved. In some such embodiments, heating coating 16 is formed from a transparent conductive oxide material and is configured to deliver power of at least 400 W per m² of area of the inner surface 24 to the glass laminate article, and in specific modeling discussed below, heating coating 16 is modeled as delivering power of 600 W per m² of area of the inner surface 24. In particular embodiments, heating coating 16 is formed from fluorine-doped tin oxide (SnO2:F), indium tin oxide (ITO), or thin stacks of oxides and metallic silver.

As noted, Applicant has determined that glass laminate article 10 is particularly useful as part of heating systems and methods for vehicle windows, and when used in such systems, various properties or characteristics of the different layers of glass laminate article 10 have been determined to play important roles in heating performance of glass laminate article 10. As one example, Applicant has determined that the thickness of inner glass layer 12 and of outer glass layer 18 are related to the heating efficiency of glass laminate article 10. Thus, referring to FIG. 1, inner glass layer 12 has an average thickness, T1, and outer glass layer 18 has an average thickness, T2, T1 is in a range from 0.05 mm to 1.5 mm, specifically from 0.05 mm to 1 mm, and more specifically from 0.1 mm and 0.8 mm. In specific embodiments, T1 is less than or equal to 0.7 mm, is about 0.5 mm (e.g., 0.5 mm plus or minus 10%) or is about 0.7 mm (e.g., 0.7 mm plus or minus 10%). In addition, T2 is greater than T1 and in specific embodiments, T2 is in a range from 1 mm to 4 mm.

In various embodiments, interlayer 14 includes an average thickness, T3, and in various embodiments, T3 is between 0.1 mm and 1 mm, and specifically is between 0.7 mm and 0.8 mm. In addition, by utilizing a thin, inner glass layer 12 combined with a thicker outer glass layer 18, glass laminate article 10 has a relatively low total average thickness, T4, and in specific embodiments, T4 is less than 4 mm. Applicant has found that by lowering the overall thickness of glass laminate article 10 better temperature distribution through the laminate can be achieved, which in turn relates to faster/more efficient defrosting/defogging of the laminate.

In addition to thicknesses, inner glass layer 12 and outer glass layer 18 are formed from glass materials having levels of thermal conductivity Applicant has determined as facilitating the effective use of glass laminate article as part of a vehicle window heating system. In particular, inner glass layer 12 is formed from a glass material having a high level of thermal conductivity, such as a thermal conductivity greater than 0.95 W/mK. In specific embodiments, the thermal conductive of inner glass layer 12 is greater than the thermal conductivity of outer glass layer 18, and in some such embodiments, the thermal conductivity of inner glass layer 12 is at least 20% greater than the thermal conductivity of outer glass layer 18. In some embodiments, outer glass layer 18 is formed from a glass composition that is different from the glass composition of inner glass layer 12, and in some embodiments, the thermal conductivity of the material of outer glass layer 18 is less than that of inner glass layer 12. In one such embodiment, the thermal conductivity of the material of outer glass layer 18 is less than 0.95 W/mK.

In specific embodiments, inner glass layer 12 is formed from a chemically strengthened alkali aluminosilicate glass composition or an alkali aluminoborosilicate glass composition, and the external glass layer is formed from a soda lime glass (SLG) composition. In such embodiments, inner glass layer 12 is a thin layer providing high heat transfer, low weight and high strength, while outer glass layer 18 forms the bulk of the thickness of glass laminate article 10. Thus, in this arrangement, the high thermal conductivity of the material of inner glass layer 12 is balanced by the lower thermal conductivity of outer glass layer 18 (and of interlayer 14) such that the aggregate thermal conductivity of glass laminate article 10 is less than 0.550 W/mK.

In addition to providing improved heating performance, glass laminate article 10, and inner glass layer 12, in particular, is configured to provide other functions that make it suitable for use in a vehicle window application. For example, the low thickness of inner glass layer 12 decreases the overall weight of glass laminate article 10 (as compared to some conventional glass laminate articles that utilize a thicker inner layer). In addition, to provide high strength and shatter resistance to glass laminate article 10, inner glass layer 12 is a highly strengthened glass layer. In such embodiments, inner glass layer 12 has a compressive stress on inner surface 20 that is at least 300 MPa.

In specific embodiments, inner glass layer 12 is a chemically strengthened material, such as an alkali aluminosilicate glass material or an alkali aluminoborosilicate glass composition, having a chemically strengthened compression layer having a depth of compression (DOC) in a range from about 30 μm to about 90 μm, and a compressive stress on inner surface 20 of between 300 MPa to 1000 MPa. In some embodiments, the chemically strengthened glass is strengthened through ion exchange, and the strengthening can be provided to inner glass layer 12 either before or after being bonded into the laminate structure.

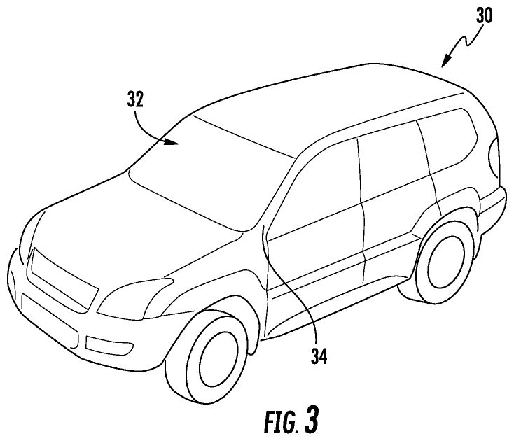

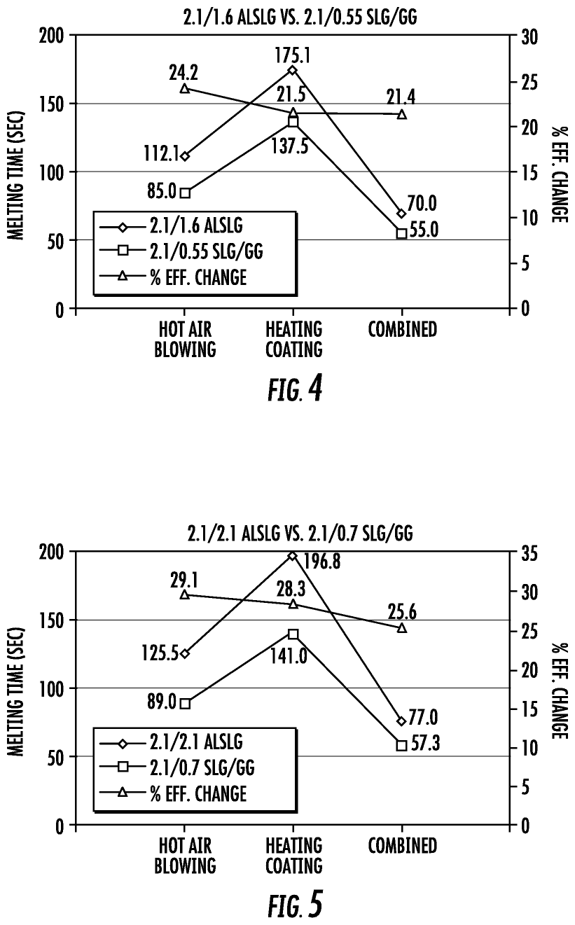

Referring to FIGS. 2 and 3, use of glass laminate article 10 as part of a vehicle window heating system and method are shown and described. As shown, a vehicle 30 includes one or more window 32, and glass laminate article 10 forms all of or part of window 32. In general, window 32 is supported within an opening defined by vehicle frame or body 34 such that inner surface 20 of glass laminate article 10 faces a vehicle interior 36. In this arrangement, outer surface 26 of glass laminate article 10 faces toward the exterior of vehicle 30 and may define the outermost surface of window 32.

As noted above, glass laminate article 10 has been determined by Applicant to be particularly useful as part of a vehicle heating system, such as a defogging/defrosting system. As shown in FIG. 2, vehicle 30 includes a heating system 40 and a power supply 42. In general, heating system 40 is a system configured to deliver energy to glass laminate article 10 and power supply 42 is an energy source for heating system 40. In some embodiments, heating system 40 includes a conventional hot air blowing system, heating coating layer 16 or a combination of a hot air blowing system and heating coating layer 16. Whether heating system 40 includes a conventional hot air blowing system, heating coating layer 16 or both, the improved heating efficiency of glass laminate article 10 provides high heating efficiency, and specifically high defogging and defrosting efficiency.

Specifically, in one embodiment, heating system 40 combines both heating coating layer 16 with a conventional hot air blower (e.g., blowing hot air from a vehicle engine), and the thermal properties of glass laminate article 10 allow fast melting of a frost layer located on outer surface 26. For example, in one embodiment, glass laminate article 10 combined with heating system 40 is configured to transfer heat through glass laminate article 10 at a high heat transfer rate such that a frost layer on outer surface 26 is melted in less 120 seconds and, more specifically, in less than 80 seconds. In such embodiments, the frost layer has an average thickness of 0.1 mm, a density of 150 kg/m³, a film coefficient of 1 W/m²° C. and an initial temperature of −20° C. In the various tests and models discussed below related to heating performance of glass laminate article 10, the blowing hot air is treated as a convection with a film coefficient of 50 W/m²° C. at 40° C. ambient temperature.

In such embodiments, heating system 40 operates to heat inner glass layer 12, for example through application of hot air onto inner surface 20, via the hot air blowing system. Heat is quickly transferred through thin, high heat conducting inner glass layer 12 as discussed above, through interlayer 14 and through external layer 18 to melt frost (or evaporate water in the case of defogging applications) located on outer surface 26. In specific embodiments, heat is also delivered from heating coating, 16 further increasing heating efficiency provided by glass laminate article 10.

In a specific embodiment, vehicle 30 is an electric vehicle incorporating the high heating efficiency glass laminate article 10 as discussed above. In such embodiments, Applicant believes that the high heat transfer efficiency is particularly advantageous as the heat generated for defogging/defrosting in such an electric vehicle typically will be generated by the electrical power supply (e.g., battery of the vehicle) as opposed to utilizing excess heat as in conventional internal combustion vehicles. By requiring less energy for window defogging/defrosting, glass laminate article 10 is expected to improve overall efficiency for such electric vehicles.

In addition to use as part of a vehicle defogging/defrosting system, glass laminate article 10 may also be configured to provide additional functionality to vehicle 30. For example, in some embodiments, glass laminate article 10 is configured to operate as part of a heads up display (HUD). In such embodiments, heating coating 16 may be configured to prevent interference with the HUD images. Similarly, inner surface 20 of inner glass layer 12 may be shaped to facilitate HUD formation.

Defrosting Examples

Referring to FIGS. 4-9, various models and tests demonstrating the heating efficiency and defrosting efficiency of glass laminate article 10 are shown according to various embodiments. The materials and properties of various layers of glass laminate article 10 that were used to develop the data shown in FIGS. 4-9 are set forth in Table 1 below. In addition, the frost in the various models discussed below is modeled having the following properties: frost density of 150 kg/m³, frost thickness of 0.1 mm, frost film coefficient of 1 W/m², and initial temperature of −20° C. In models utilizing blown hot air as part of the modeled heating system, the blown hot air is treated as a convection with a film coefficient of 50 W/m²° C. at 40° C. ambient temperature

TABLE 1

| | | Thermal | | |
|---|---|---|---|---|
| Layer in | | Conductivity | Specific Heat | Density |
| FIG. 1 | Material | (W/mC) | (J/kgC) | (kg/m³) |
| 12 | Gorilla Glass | 1.207 | 972 | 2440 |
| 14 | PVB | 0.208 | 1967.8 | 1070 |
| 18 | SLG | 0.937 | 880 | 2530 |
| NA | Frost | 0.15 | 2040 (Ice) | 150 |
| | | | 4180 (Water) | |

Referring to FIG. 4, results of melting time modeling for two types of glass laminates; a “conventional” laminate having outer and inner layers both made of SLG having thicknesses of 2.1 mm and 1.6 mm, respectively, and an embodiment of glass laminate article 10 having an outer layer of SLG having a thickness of 2.1 mm and an inner layer of Corning Gorilla Glass (hereinafter GG) having a thickness of 0.55 mm. In addition, FIG. 4 shows the melting time and efficiency for both laminate articles utilizing three different heating methods: hot air blowing, heating coating, and combined hot air blowing and heating coating. As shown in FIG. 4, a 21.4˜24.2% improvement in melting time is achieved by the replacement of the inner 1.6 mm SLG layer with a 0.55 mm GG layer.

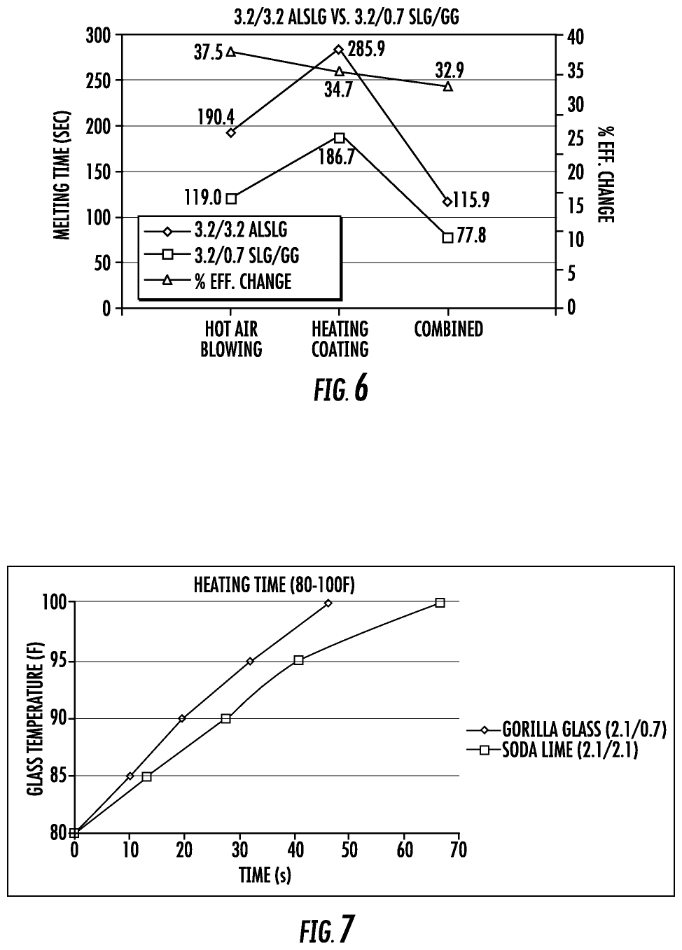

Referring to FIG. 5, results of melting time modeling for two types of glass laminates: a “conventional” laminate having outer and inner layers both made of SLG, both having thicknesses of 2.1 mm, and an embodiment of glass laminate article 10 having an outer glass layer 18 of SLG with a thickness of 2.1 mm and an inner glass layer 12 of GG having a thickness of 0.7 mm. In addition, FIG. 5 shows the melting time and efficiency for both laminate articles utilizing three different heating methods: hot air blowing, heating coating, and combined hot air blowing and heating coating. As shown in FIG. 5, a 25.6˜29.1% improvement in melting time is achieved by the replacement of the inner 2.1 mm SLG layer with a 0.7 mm GG layer.

Referring to FIG. 6, results of melting time modeling for two types of glass laminates: a “conventional” laminate having outer and inner layers both made of SLG, both having thicknesses of 3.2 mm, and an embodiment of glass laminate article 10 having an outer glass layer 18 of SLG having a thickness of 3.2 mm and an inner glass layer 12 of GG having a thickness of 0.7 mm. Like FIGS. 4 and 5, FIG. 6 shows the melting time and efficiency for both laminate articles utilizing three different heating methods: hot air blowing, heating coating, and combined hot air blowing and heating coating. As shown in FIG. 6, a 32.9˜37.5% improvement in melting time is achieved by the replacement of the inner 3.2 mm SLG layer with the 0.7 mm GG layer.

Referring to FIG. 7, results of a heating time comparison experiment are shown. FIG. 7 shows heating times for a “conventional” laminate having outer and inner layers both made of SLG, both having thicknesses of 2.1 mm, and an embodiment of glass laminate article 10 having an outer glass layer 18 of SLG having a thickness of 2.1 mm and an inner glass layer 12 of GG having a thickness of 0.7 mm. As shown, the glass laminate including the thin inner GG layer heats approximately 30% faster than the conventional SLG laminate.

Referring to FIG. 8, the effect of thickness of the interior glass layer 12 (Ply 2) on melting time is shown. In this model, thickness of the outer glass layer 18 (Ply 1) is fixed as 2.1 mm, and thickness of inner glass layer 12 is varied from 0.5 mm to 2.5 mm for both cases of SLG/SLG and SLG/GG laminates. If a soda lime inner glass layer is replaced by the same thickness of GG, FIG. 8 shows that melting times vary based on the thickness of inner glass layer 12 in the same manner for both material types.

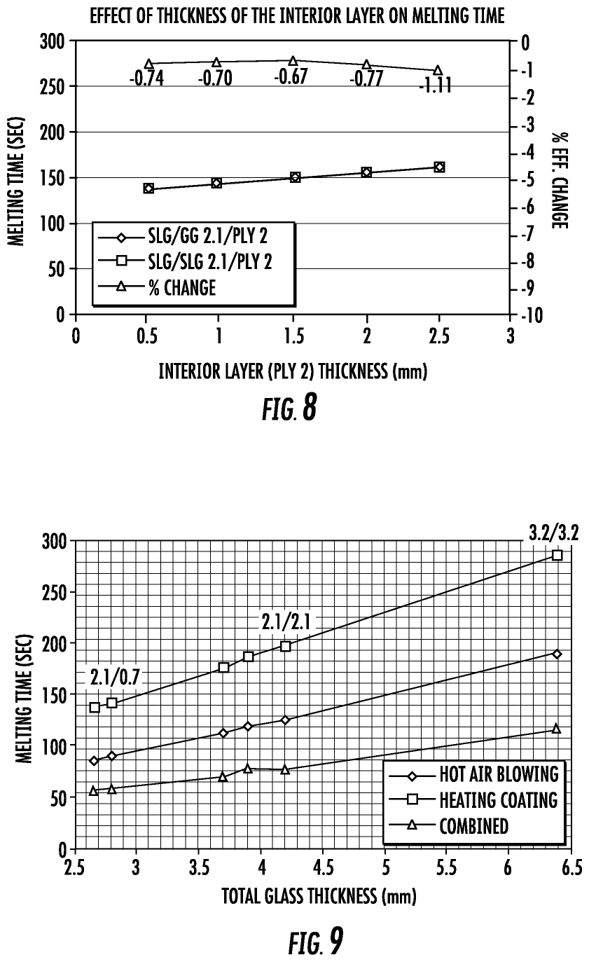

FIG. 9 shows modeling results of the effect of total glass laminate thickness on frost melt times for three heating systems: hot air alone, heating coating alone, and combined hot air and heating coating. As shown in FIG. 9, melting time appears proportional to the total thickness of the glass laminate to the first order. In addition, FIG. 9 shows that the combined heating system achieves the fastest melt times.

### Defogging Examples

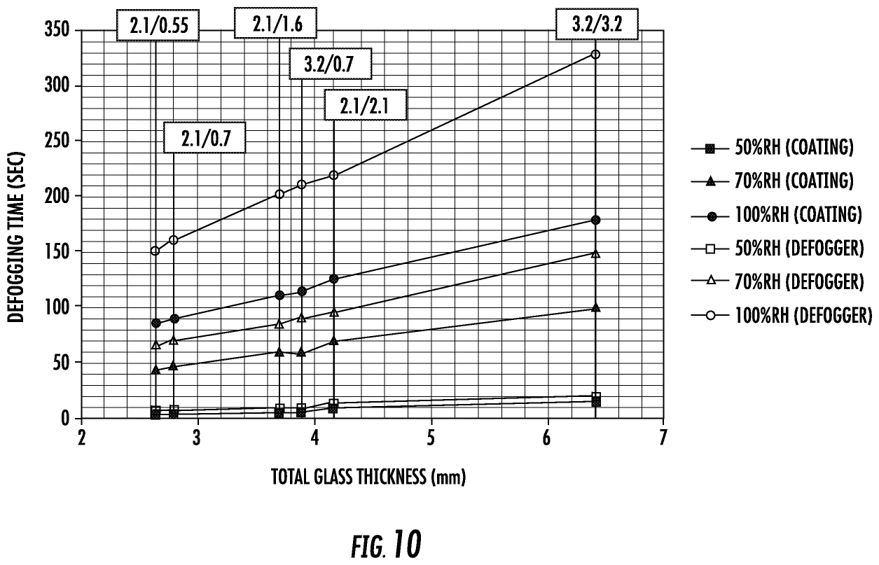

Referring to FIGS. 10-13, various models demonstrating the heating efficiency and defogging efficiency of glass laminate article 10 are shown according to various embodiments. The materials and properties of various layers of glass laminate article 10 that were used to develop the data shown in FIGS. 10-13 are set forth in Table 1 above. While defogging time varies based on a number of environmental factors including air temperature and relative humidity, Applicant has determined that significant defogging efficiency (e.g., up to 52.7% in Applicant's modeling) can be achieved through use of glass laminate article 10 as discussed herein. Further in these models, the fog is modeled having the following properties: fog density of 1000 kg/m³, fog thickness of 0.1 mm, fog thermal conductivity of 0.15 W/mK and a fog film coefficient of 1 W/m².

FIG. 10 is a plot of defogging time vs. total glass laminate thickness depending on defogging methods (either heating coating alone or blown hot air alone) and relative humidity (RH) in case of fog formation on the outer surface of a windshield (e.g., temperature falling down during the night or early morning outside the car or switching on the AC in summer). As shown in FIG. 10, it appears that defogging time is proportional to the total thickness of the laminate (the combined thicknesses of Ply 1 and Ply 2) to the first order. In addition, the conventional defogger takes a longer time to defog the outer windshield surface as compared with that of the transparent heating coating. Applicant believes that the improvement in defogging achieved by the heating coating as shown in FIG. 10 is provided, at least in part, by the positioning of heating coating 16 between interlayer 14 and outer glass layer 18 (as shown in FIG. 1) and closer to the outermost surface of glass laminate article 10.

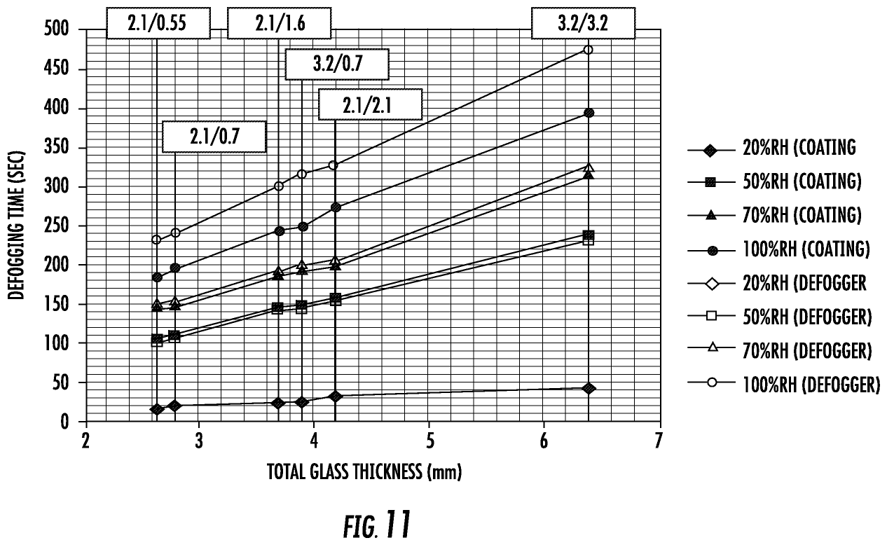

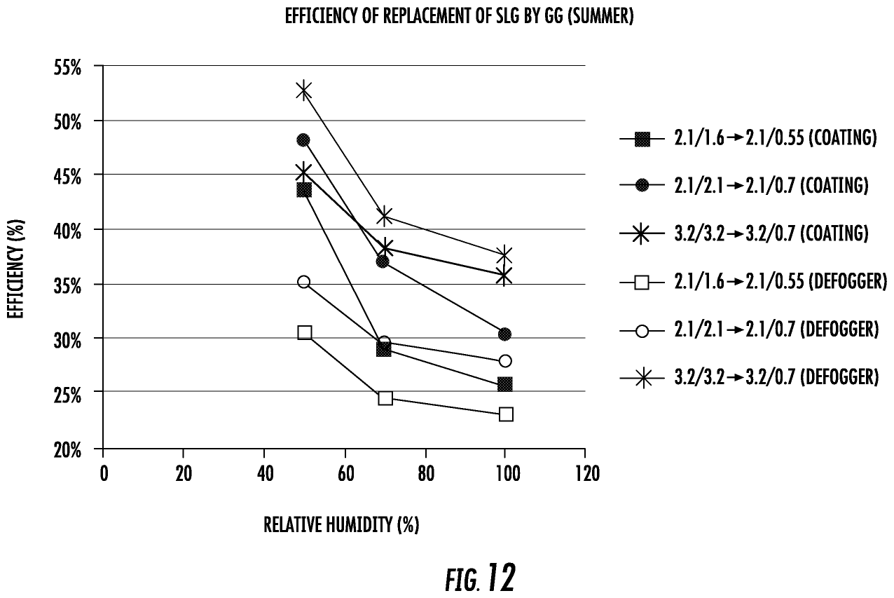

FIG. 11 is a plot of defogging time vs. total glass thickness depending on defogging methods and relative humidity (RH) in case of fog formation on the inside of the glass laminate (e.g., switching on the heater in the winter). It appears that defogging time is proportional to the total thickness of the laminate (the combined thicknesses of Ply 1 and Ply 2) to the first order. In addition, the conventional defogger takes a longer time to defog the inner windshield surface as compared with that of the transparent heating coating. In case of the fog formation on the windshield inside as shown in FIG. 11, it takes 1.5˜18 times longer to defog the windshield than the case of the fog formation on the outer windshield (FIG. 10).

FIG. 12 shows results of defogging time improvement percentage by using GG as the inner glass layer 12 (Ply 2) under various conditions. These results are obtained from the case of fog formation on the outer surface of the glass laminate (e.g., outer surface of a windshield, temperature falling down during the night or early morning outside the car or switching on the AC in summer). This plot shows the relation of total glass thickness, defogging method, and relative humidity on the defogging efficiency improvement. Defogging efficiency increases exponentially as relative humidity decreases. In addition, FIG. 12 shows that use of transparent heating coating provides better defogging efficiency compared with the conventional defogger regardless of relative humidity. Specifically, FIG. 12 shows that the blown air defogger takes between 1.5 and 2 times longer to defog the outside of the glass as compared to a glass laminate using heating layer 16 for defogging, for various glass thicknesses and various levels of relative humidity. In addition, thicker glass laminates (e.g., those in which outer glass layer 18 (Ply 1) is 3.2 mm) show better defogging efficiency gains than thinner glass laminates (e.g., those in which outer glass layer 18 (Ply 1) is 2.1 mm) for a given defogging method. As will generally be understood defrosting/defogging time increases as total thickness of glass laminates increases, but the defogging/defrosting efficiency increases as total thickness of glass laminates increases when the inner layer of glass is replaced with a thin chemically tempered glass (such as Gorilla Glass). FIG. 12 shows that replacement of a soda lime inner glass layer with a chemically tempered glass, such as Gorilla Glass is more effective in defrosting/defogging (i.e., has a larger effect on defrosting/defogging gains) in the case of thicker glass laminates.

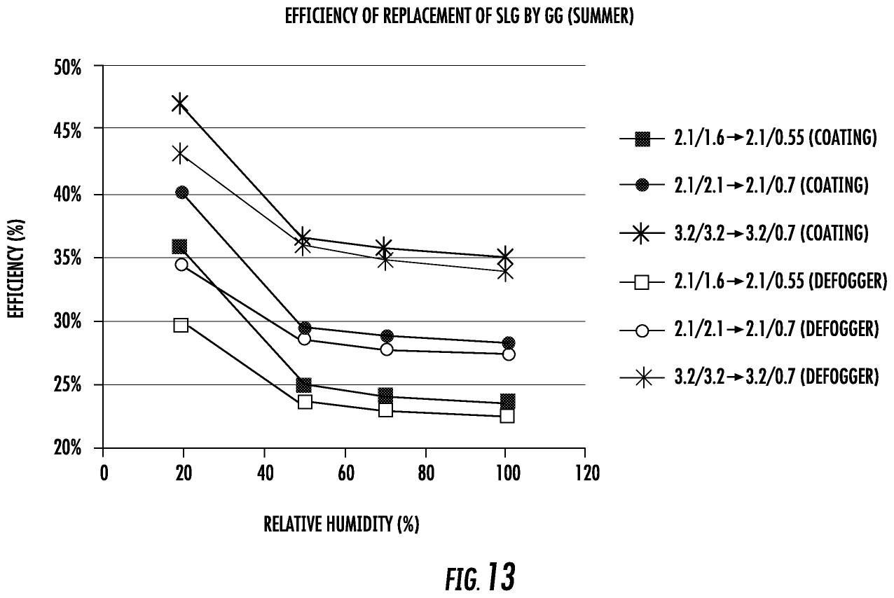

FIG. 13 shows the results of defogging time improvement percentage by using GG as the inner glass layer 12 (Ply 2) under various conditions. These results are obtained for the case of fog formation on the inner surface of the glass laminate (e.g., inner surface of a windshield by switching on the heater in the winter). This plot shows the relation of total glass thickness, defogging method, and relative humidity on the defogging efficiency improvement. Defogging efficiency increases exponentially as relative humidity decreases. The method of the transparent heating coating shows better defogging efficiency compared with the conventional defogger regardless of relative humidity. Specifically, FIG. 13 shows that the blown air defogger takes between 0.94 and 1.3 times longer to defog the outside of the glass as compared to a glass laminate using heating coating 16 for defogging, for various glass thicknesses and various levels of relative humidity. In addition, thicker glass laminates (e.g., those in which outer glass layer 18 (Ply 1) is 3.2 mm) show better defogging efficiency than thinner glass laminates (e.g., those in which outer glass layer 18 (Ply 1) is 2.1 mm) for a given defogging method.

### Examples of Glass Materials and Properties

In various embodiments, inner glass layer 12 may be formed from any of a variety of strengthened glass compositions. Examples of glasses that may be used for inner glass layer 12 of glass laminate article 10 described herein may include alkali aluminosilicate glass compositions or alkali aluminoborosilicate glass compositions, though other glass compositions are contemplated. Such glass compositions may be characterized as ion exchangeable. As used herein, “ion exchangeable” means that the layer comprising the composition is capable of exchanging cations located at or near the surface of the glass layer with cations of the same valence that are either larger or smaller in size. In one exemplary embodiment, the glass composition of inner glass layer 12 comprises SiO₂, B₂O₃ and Na₂O, where (SiO₂+B₂O₃)≥66 mol. %, and Na₂O≥9 mol. %. Suitable glass compositions for inner glass layer 12, in some embodiments, further comprise at least one of K₂O, MgO, and CaO. In a particular embodiment, the glass compositions used in inner glass layer 12 can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example of glass composition suitable for inner glass layer 12 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. % (Li₂O+Na₂O+K₂O)≤20 mol. % and 0 mol. % (MgO+CaO)≤10 mol. %.

A still further example of glass composition suitable for inner glass layer 12 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for inner glass layer 12 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio ((Al₂O₃+B₂O₃)/Σ modifiers)>1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio ((Al₂O₃+B₂O₃)/Σmodifiers)>1.

In still another embodiment, the inner glass layer 12 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)—Al₂O₃≤2 mol. %; 2 mol. %≤Na₂O—Al₂O₃≤6 mol. %; and 4 mol. %≤(Na₂O+K₂O)—Al₂O₃≤10 mol. %.

In an alternative embodiment, inner glass layer 12 may comprise an alkali aluminosilicate glass composition comprising: 2 mol % or more of Al₂O₃ and/or ZrO₂, or 4 mol % or more of Al₂O₃ and/or ZrO₂. In one or more embodiments, inner glass layer 12 comprises a glass composition comprising SiO₂ in an amount in the range from about 67 mol % to about 80 mol %, Al₂O₃ in an amount in a range from about 5 mol % to about 11 mol %, an amount of alkali metal oxides (R₂O) in an amount greater than about 5 mol % (e.g., in a range from about 5 mol % to about 27 mol %). In one or more embodiments, the amount of R₂O comprises Li₂O in an amount in a range from about 0.25 mol % to about 4 mol %, and K₂O in an amount equal to or less than 3 mol %. In one or more embodiments, the glass composition includes a non-zero amount of MgO, and a non-zero amount of ZnO.

In other embodiments, inner glass layer 12 is formed from a composition that exhibits SiO₂ in an amount in the range from about 67 mol % to about 80 mol %, Al₂O₃ in an amount in the range from about 5 mol % to about 11 mol %, an amount of alkali metal oxides (R₂O) in an amount greater than about 5 mol % (e.g., in a range from about 5 mol % to about 27 mol %), wherein the glass composition is substantially free of Li₂O, and a non-zero amount of MgO; and a non-zero amount of ZnO.

In other embodiments, inner glass layer 12 is formed from an aluminosilicate glass article comprising: a glass composition comprising SiO₂ in an amount of about 67 mol % or greater; and a sag temperature in a range from about 600° C. to about 710° C. In other embodiments, inner glass layer 12 is formed from an aluminosilicate glass article comprising: a glass composition comprising SiO₂ in an amount of about 68 mol % or greater; and a sag temperature in a range from about 600° C. to about 710° C. (as defined herein). In some embodiments, glass laminate article 10 and/or inner glass layer 12 is a glass article that can be pair sagged with another glass article that differs in any one or more of composition, thickness, strengthening level, and forming method (e.g., float formed as opposed to fusion formed). In one or more embodiments, the glass article described has a sag temperature of about 710° C., or less or about 700° C. or less. In one or more embodiments, the glass article described herein may be pair sagged with a SLG article. In one or more embodiments, this glass article comprises a glass composition comprising SiO₂ in an amount in the range from about 68 mol % to about 80 mol %, Al₂O₃ in an amount in a range from about 7 mol % to about 15 mol %, B₂O₃ in an amount in a range from about 0.9 mol % to about 15 mol %; a non-zero amount of P₂O₅ up to and including about 7.5 mol %, Li₂O in an amount in a range from about 0.5 mol % to about 12 mol %, and Na₂O in an amount in a range from about 6 mol % to about 15 mol %.

In some embodiments, the glass composition of inner glass layer 12 may include an oxide that imparts a color or tint to the glass articles. In some embodiments, the glass composition of inner glass layer 12 includes an oxide that prevents discoloration of the glass article when the glass article is exposed to ultraviolet radiation. Examples of such oxides include, without limitation oxides of: T1, V, Cr, Mn, Fe, Co, Ni, Cu, Ce, W, and Mo.

Referring back to FIG. 1, embodiments of glass laminate article 10 include a first major outer surface 26 which is the outer surface of outer glass layer 18, an opposing second major surface 20, which is the inner surface of inner glass layer 12. A thickness T4 is defined between the first major surface and the second major surface.

In one or more embodiments, T4 may be about 3 millimeters or less (e.g., in the range from about 0.01 millimeter to about 3 millimeters, from about 0.1 millimeter to about 3 millimeters, from about 0.2 millimeter to about 3 millimeters, from about 0.3 millimeter to about 3 millimeters, from about 0.4 millimeter to about 3 millimeters, from about 0.01 millimeter to about 2.5 millimeters, from about 0.01 millimeter to about 2 millimeters, from about 0.01 millimeter to about 1.5 millimeters, from about 0.01 millimeter to about 1 millimeter, from about 0.01 millimeter to about 0.9 millimeter, from about 0.01 millimeter to about 0.8 millimeter, from about 0.01 millimeter to about 0.7 millimeter, from about 0.01 millimeter to about 0.6 millimeter, from about 0.01 millimeter to about 0.5 millimeter, from about 0.1 millimeter to about 0.5 millimeter, or from about 0.3 millimeter to about 0.5 millimeter.)

Glass laminate article 10 and/or its glass layers 12 and 18 may be substantially planar sheets, although other embodiments may utilize a curved or otherwise shaped or sculpted article. In some instances, the surfaces of glass laminate article 10 may have a 3D or 2.5D shape. Additionally or alternatively, the thickness of the glass laminate article 10 may be constant along one or more dimension or may vary along one or more of its dimensions for aesthetic and/or functional reasons. For example, the edges of the glass article may be thicker as compared to more central regions of the glass article. The length, width and thickness dimensions of the glass article may also vary according to the article application or use. In some embodiments, glass laminate article 10 may have a wedged shape in which the thickness at one end is greater than the thickness at an opposing end. Where the thickness varies, the thickness ranges disclosed herein are the maximum thickness between the major surfaces.

Glass laminate article 10 and/or its glass layers may have a refractive index in the range from about 1.45 to about 1.55. As used herein, the refractive index values are with respect to a wavelength of 550 nm.

Glass laminate article 10 and/or its glass layers may be characterized by the manner in which it is formed. For instance, the glass article may be characterized as float-formable (i.e., formed by a float process), down-drawable and, in particular, fusion-formable or slot-drawable (i.e., formed by a down draw process such as a fusion draw process or a slot draw process).

In one or more embodiments, glass laminate article 10 and/or its glass layers described herein may exhibit an amorphous microstructure and may be substantially free of crystals or crystallites. In other words, in such embodiments, the glass articles exclude glass-ceramic materials.

In one or more embodiments, inner glass layer 12 exhibits an average total solar transmittance of about 88% or less, over a wavelength range from about 300 nm to about 2500 nm, when inner glass layer 12 has a thickness of 0.7 mm. For example, inner glass layer 12 exhibits an average total solar transmittance in a range from about 60% to about 88%, from about 62% to about 88%, from about 64% to about 88%, from about 65% to about 88%, from about 66% to about 88%, from about 68% to about 88%, from about 70% to about 88%, from about 72% to about 88%, from about 60% to about 86%, from about 60% to about 85%, from about 60% to about 84%, from about 60% to about 82%, from about 60% to about 80%, from about 60% to about 78%, from about 60% to about 76%, from about 60% to about 75%, from about 60% to about 74%, or from about 60% to about 72%.

In one or embodiments, inner glass layer 12 exhibits an average transmittance in the range from about 75% to about 85%, at a thickness of 0.7 mm or 1 mm, over a wavelength range from about 380 nm to about 780 nm. In some embodiments, the average transmittance at this thickness and over this wavelength range may be in a range from about 75% to about 84%, from about 75% to about 83%, from about 75% to about 82%, from about 75% to about 81%, from about 75% to about 80%, from about 76% to about 85%, from about 77% to about 85%, from about 78% to about 85%, from about 79% to about 85%, or from about 80% to about 85%. In one or more embodiments, inner glass layer 12 exhibits Tᵤᵥ₋₃₈₀ or Tᵤᵥ₋₄₀₀ of 50% or less (e.g., 49% or less, 48% or less, 45% or less, 40% or less, 30% or less, 25% or less, 23% or less, 20% or less, or 15% or less), at a thickness of 0.7 mm or 1 mm, over a wavelength range from about 300 nm to about 400 nm.

In one or more embodiments, inner glass layer 12 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In one or more embodiments, inner glass layer 12 may be strengthened mechanically by utilizing a mismatch of the coefficient of thermal expansion between portions of the article to create a compressive stress region and a central region exhibiting a tensile stress. In some embodiments, the glass article may be strengthened thermally by heating the glass to a temperature below the glass transition point and then rapidly quenching.

In one or more embodiments, inner glass layer 12 may be chemically strengthening by ion exchange. In the ion exchange process, ions at or near the surface of inner glass layer 12 are replaced by—or exchanged with—larger ions having the same valence or oxidation state. In those embodiments in which inner glass layer 12 comprises an alkali aluminosilicate glass, ions in the surface layer of the article and the larger ions are monovalent alkali metal cations, such as Li⁺, Na⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into inner glass layer 12 generate a stress.

In one or more embodiments, layers 12 and 18 of glass laminate article 10 may be formed from a glass article/sheet that is strengthened, as described herein. In one or more embodiments, inner glass layer 12 comprises a chemically, mechanically or thermally strengthened glass, while outer glass layer 18 is not strengthened. In one or more embodiments, inner glass layer 12 comprises a chemically or thermally strengthened glass, while outer glass layer 18 is annealed. In one or more embodiments, inner glass layer 12 comprises a chemically, mechanically or thermally strengthened glass, while outer glass layer 18 is strengthened in different manner than the first glass layer (chemically, mechanically and/or thermally). In one or more embodiments, inner glass layer 12 comprises a chemically, mechanically or thermally strengthened glass, while outer glass layer 18 is strengthened in the same manner as inner glass layer 12 (chemically, mechanically and/or thermally).

Glass laminate article 10 can be used for a variety of different applications, devices, uses, etc. In various embodiments, glass laminate article 10 may form the sidelights, windshields, rear windows, windows, rearview mirrors, and sunroofs of vehicle 30. As used herein, vehicle includes automobiles, rolling stock, locomotive, boats, ships, and airplanes, helicopters, drones, space craft and the like. It should be understood that while the above description primarily describes glass laminate article 10 as being used as vehicle window and as part of a vehicle defogging/defrosting system, glass laminate article 10 may be used in a variety of other applications where the combination of high strength and heat transfer are advantageous. For example, glass laminate article 10 may be used as architectural glass, building glass, etc. In addition, glass laminate article 10 may be used for glass in variety of articles or devices intended for outdoor use (e.g., camera lens, binoculars, goggles, etc.) for which heat transfer efficiency increases defogging or defrost rates.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

Aspect (1) of this disclosure pertains to a glass laminate article comprising: a strengthened inner glass layer comprising: (i) an inner surface, (ii) an outer surface opposite the inner surface, and (iii) an average thickness between the inner and outer surfaces in a range from 0.05 mm to 1 mm; an interlayer disposed on the outer surface of the inner glass layer; an external glass layer comprising: (i) an inner surface, (ii) an outer surface, and (iii) an average thickness between the inner and outer surfaces in a range from 1 mm to 4 mm; and a heating coating located between the inner surface of the external glass layer and the interlayer.

Aspect (2) of this disclosure pertains to the glass laminate article of Aspect (1), wherein the heating coating comprises a transparent conductive oxide material, and is configured to deliver power of at least 400 W per m² of area of the inner surface of the external glass layer to the glass laminate article.

Aspect (3) of this disclosure pertains to the glass laminate article of Aspect (1) or Aspect (2), wherein the inner glass layer comprises a compressive stress on the inner surface of at least 300 MPa.

Aspect (4) of this disclosure pertains to the glass laminate article of any one of Aspects (1) through (3), wherein the inner glass layer comprises: an alkali aluminosilicate glass composition, or an alkali aluminoborosilicate glass composition; a chemically strengthened compression layer including DOC in a range from about 30 μm to about 90 μm; and a compressive stress on the inner surface of between 300 MPa to 1000 MPa.

Aspect (5) of this disclosure pertains to the glass laminate article of any one of Aspects (1) through (4), wherein the interlayer is a polymer selected from the group consisting of polyvinyl butyral, ethylenevinylacetate, polyvinyl chloride, ionomers, and thermoplastic polyurethane.

Aspect (6) of this disclosure pertains to the glass laminate article of any one of Aspects (1) through (5), wherein the inner glass layer is formed from a first glass composition and the external glass layer is formed from a second glass composition different from the first glass composition.

Aspect (7) of this disclosure pertains to the glass laminate article of Aspect (6), wherein a thermal conductivity of the first glass composition is greater than 0.95 W/mK and a thermal conductivity of the second glass composition is less than 0.95 W/mK.

Aspect (8) of this disclosure pertains to the glass laminate article of any one of Aspects (1) through (7), wherein an aggregate thermal conductivity of the glass laminate is less than 0.550 W/mK.

Aspect (9) of this disclosure pertains to the glass laminate article of any one of Aspects (1) through (8), further comprising a portion of the inner surface of the inner glass layer forming a display for a heads up display.

Aspect (10) of this disclosure pertains to a vehicle comprising: a body comprising an interior; an opening in the body in communication with interior; and a window disposed in the opening, the window comprising the glass laminate article of any one of Aspects (1) through (9).

Aspect (11) of this disclosure pertains to the vehicle of Aspect (10), wherein the vehicle is an electric vehicle.

Aspect (12) of this disclosure pertains to a system for efficiently heating an external surface of a glass laminate article comprising: a strengthened inner glass layer comprising: (i) an inner surface, (ii) an outer surface opposite the inner surface, and (iii) an average thickness between the inner and outer surfaces of 0.05 mm and 1.5 mm; an interlayer disposed on the outer surface of the inner glass layer; an external glass layer comprising: (i) an inner surface, (ii) an outer surface, and (iii) an average thickness between the inner surface and the outer surface that is greater than the average thickness of the strengthened inner glass layer; and a heating coating located between the interlayer and the external glass layer; wherein the heating coating delivers a power of at least 400 W per m² of area of the inner surface of the external glass layer to the glass laminate article.

Aspect (13) of this disclosure pertains to the system of Aspect (12), further comprising a blower configured to blow hot air onto the inner surface of the inner glass layer, wherein a total average thickness of the glass laminate article between the inner surface of the inner glass layer and the outer surface of the external glass layer is less than 4 mm, and further wherein the blower and the heating coating provide heat to quickly heat the glass laminate article such that a frost layer located on the outer surface of the outer glass layer is melted in less than 80 seconds, wherein the frost layer has an average thickness of 0.1 mm, a density of 150 kg/m³, a film coefficient of 1 W/m²° C. and an initial temperature of minus 20 degrees C.

Aspect (14) of this disclosure pertains to a method of efficiently and quickly heating an exterior surface of a window of a vehicle comprising: heating an inner glass layer of the window, wherein the inner glass layer comprises: an inner surface defining an interior surface of the vehicle window, an outer surface opposite the inner surface, an average thickness between the inner and outer surfaces of between 0.05 mm and 1 mm, and a first glass composition having a thermal conductivity greater than 0.95 W/mK; and heating an outer glass layer of the window, wherein the outer glass layer comprises: an inner surface facing the exterior surface of the inner glass layer, and an outer surface opposite the inner surface; and an average thickness between the inner and outer surfaces of greater than 1 mm; and wherein heat is transferred across both the inner glass layer and the outer glass layer to melt frost located on the outer surface of the outer glass layer.

Aspect (15) of this disclosure pertains to the method of Aspect (14), wherein the outer glass layer comprises a second glass composition different from the first glass composition, the second glass composition having a thermal conductivity less than 0.95 W/mK.

Aspect (16) of this disclosure pertains to the method of Aspect (14) or Aspect (15), wherein the thermal conductivity of the inner glass layer is at least 20% greater than the thermal conductivity of the outer glass layer.

Aspect (17) of this disclosure pertains to the method of any one of Aspects (14) through (16), wherein heating of the inner and outer glass layers comprises applying heated, blown air onto the inner surface of the inner glass layer, the method further comprising melting a frost layer located on the exterior surface of the outer glass layer via the application of heated air in less than 120 seconds, wherein the frost layer has an average thickness of 0.1 mm, a density of 150 kg/m³, a film coefficient of 1 W/m²° C. and an initial temperature of minus 20 degrees C.

Aspect (18) of this disclosure pertains to the method of Aspect (17), wherein the heated, blown air comprises air generated from a vehicle heating system.

Aspect (19) of this disclosure pertains to the method of any one of Aspects (14) through (16), wherein heating of the inner and outer glass layers comprises applying heat from a transparent heating coating material located on the inner surface of the outer glass layer.

Aspect (20) of this disclosure pertains to the method of Aspect (19), wherein the heating coating delivers power of at least 400 W/m² to the vehicle window.

Aspect (21) of this disclosure pertains to the method of Aspect (19) or Aspect (20), wherein the vehicle window further comprises an interlayer located between the outer surface of the inner glass layer and the heating coating, wherein the interlayer includes a polymer selected from the group consisting of polyvinyl butyral, ethylenevinylacetate, polyvinyl chloride, ionomers, and thermoplastic polyurethane.

Aspect (22) of this disclosure pertains to the method of any one of Aspects (14) through (21), wherein the inner glass layer is a chemically strengthened glass material and has a thickness of less than or equal to 0.7 mm.

Aspect (23) of this disclosure pertains to the method of any one of Aspects (14) through (22), wherein the inner glass layer comprises: an alkali aluminosilicate glass composition or an alkali aluminoborosilicate glass composition; a chemically strengthened compression layer including DOC in a range from about 30 μm to about 90 μm; and a compressive stress on the inner surface of between 300 MPa to 1000 MPa.

1. A glass laminate article comprising:
a strengthened inner glass layer comprising:
an inner surface;
an outer surface opposite the inner surface; and
an average thickness between the inner and outer surfaces in a range from 0.05 mm to 1 mm;
an interlayer disposed on the outer surface of the inner glass layer;
an external glass layer comprising:
an inner surface;
an outer surface; and
an average thickness between the inner and outer surfaces in a range from 1 mm to 4 mm; and
a heating coating located between the inner surface of the external glass layer and the interlayer.

2. The glass laminate article of claim 1, wherein the heating coating comprises a transparent conductive oxide material, and is configured to deliver power of at least 400 W per m² of area of the inner surface of the external glass layer to the glass laminate article.

3. The glass laminate article of claim 1, wherein the inner glass layer comprises a compressive stress on the inner surface of at least 300 MPa.

4. The glass laminate article of claim 1, wherein the inner glass layer comprises:
an alkali aluminosilicate glass composition, or an alkali aluminoborosilicate glass composition;
a chemically strengthened compression layer including DOC in a range from about 30 μm to about 90 μm; and
a compressive stress on the inner surface of between 300 MPa to 1000 MPa.

5. The glass laminate article of claim 1, wherein the interlayer is a polymer selected from the group consisting of polyvinyl butyral, ethylenevinylacetate, polyvinyl chloride, ionomers, and thermoplastic polyurethane.

6. The glass laminate article of claim 1, wherein the inner glass layer is formed from a first glass composition and the external glass layer is formed from a second glass composition different from the first glass composition.

7. The glass laminate article of claim 6, wherein a thermal conductivity of the first glass composition is greater than 0.95 W/mK and a thermal conductivity of the second glass composition is less than 0.95 W/mK.

8. The glass laminate article of claim 1, wherein an aggregate thermal conductivity of the glass laminate is less than 0.550 W/mK.

9. The glass laminate article of claim 1, further comprising a portion of the inner surface of the inner glass layer forming a display for a heads up display.

10. A vehicle comprising:
a body comprising an interior;
an opening in the body in communication with interior; and
a window disposed in the opening, the window comprising a glass laminate article comprising:
a strengthened inner glass layer comprising:
an inner surface;
an outer surface opposite the inner surface; and
an average thickness between the inner and outer surfaces in a range from 0.05 mm to 1 mm;
an interlayer disposed on the outer surface of the inner glass layer;
an external glass layer comprising:
an inner surface;
an outer surface; and
an average thickness between the inner and outer surfaces in a range from 1 mm to 4 mm; and
a heating coating located between the inner surface of the external glass layer and the interlayer.

11. The vehicle of claim 10, wherein the vehicle is an electric vehicle.

12. A system for efficiently heating an external surface of a glass laminate article comprising:
a strengthened inner glass layer comprising:
an inner surface;
an outer surface opposite the inner surface; and
an average thickness between the inner and outer surfaces of 0.05 mm and 1.5 mm;
an interlayer disposed on the outer surface of the inner glass layer;
an external glass layer comprising:
an inner surface;
an outer surface; and
an average thickness between the inner surface and the outer surface that is greater than the average thickness of the strengthened inner glass layer; and
a heating coating located between the interlayer and the external glass layer;
wherein the heating coating delivers a power of at least 400 W per m² of area of the inner surface of the external glass layer to the glass laminate article.

13. The system of claim 12, further comprising a blower configured to blow hot air onto the inner surface of the inner glass layer, wherein a total average thickness of the glass laminate article between the inner surface of the inner glass layer and the outer surface of the external glass layer is less than 4 mm, and further wherein the blower and the heating coating provide heat to quickly heat the glass laminate article such that a frost layer located on the outer surface of the outer glass layer is melted in less than 80 seconds, wherein the frost layer has an average thickness of 0.1 mm, a density of 150 kg/m³, a film coefficient of 1 W/m²° C. and an initial temperature of minus 20 degrees C.

14. A method of efficiently and quickly heating an exterior surface of a window of a vehicle comprising:
heating an inner glass layer of the window, wherein the inner glass layer comprises:
an inner surface defining an interior surface of the vehicle window;
an outer surface opposite the inner surface;
an average thickness between the inner and outer surfaces of between 0.05 mm and 1 mm; and
a first glass composition having a thermal conductivity greater than 0.95 W/mK; and
heating an outer glass layer of the window, wherein the outer glass layer comprises:
an inner surface facing the exterior surface of the inner glass layer; and
an outer surface opposite the inner surface; and
an average thickness between the inner and outer surfaces of greater than 1 mm; and
wherein heat is transferred across both the inner glass layer and the outer glass layer to melt frost located on the outer surface of the outer glass layer.

15. The method of claim 14, wherein the outer glass layer comprises a second glass composition different from the first glass composition, the second glass composition having a thermal conductivity less than 0.95 W/mK.

16. The method of claim 14, wherein the thermal conductivity of the inner glass layer is at least 20% greater than the thermal conductivity of the outer glass layer.

17. The method of claim 14, wherein heating of the inner and outer glass layers comprises applying heated, blown air onto the inner surface of the inner glass layer, the method further comprising melting a frost layer located on the exterior surface of the outer glass layer via the application of heated air in less than 120 seconds, wherein the frost layer has an average thickness of 0.1 mm, a density of 150 kg/m³, a film coefficient of 1 W/m²° C. and an initial temperature of minus 20 degrees C.

18. The method of claim 17, wherein the heated, blown air comprises air generated from a vehicle heating system.

19. The method of claim 14, wherein heating of the inner and outer glass layers comprises applying heat from a transparent heating coating material located on the inner surface of the outer glass layer.

20. The method of claim 19, wherein the heating coating delivers power of at least 400 W/m² to the vehicle window.

21. The method of claim 19, wherein the vehicle window further comprises an interlayer located between the outer surface of the inner glass layer and the heating coating, wherein the interlayer includes a polymer selected from the group consisting of polyvinyl butyral, ethylenevinylacetate, polyvinyl chloride, ionomers, and thermoplastic polyurethane.

22. The method of claim 14, wherein the inner glass layer is a chemically strengthened glass material and has a thickness of less than or equal to 0.7 mm.

23. The method of claim 14, wherein the inner glass layer comprises:
an alkali aluminosilicate glass composition or an alkali aluminoborosilicate glass composition;
a chemically strengthened compression layer including DOC in a range from about 30 μm to about 90 μm; and
a compressive stress on the inner surface of between 300 MPa to 1000 MPa.
